(19) United States
(12) Patent Application Publication
(10) Pub. No.: US 2013/0169070 A1
(43) Pub. Date: Jul. 4, 2013

(54) VIBRATION MOTOR

(71) Applicant: Samsung Electro-Mechanics Co., Ltd., Suown (KR)

(72) Inventor: An Soo Yoon, Suwon (KR)

(73) Assignee: SAMSUNG ELECTRO-MECHANICS CO., LTD., Suwon (KR)

(21) Appl. No.: 13/728,789

(22) Filed: Dec. 27, 2012

(30) Foreign Application Priority Data
Dec. 28, 2011 (KR) 10-2011-0144915

(51) Int. Cl. H02K 33/00

(52) U.S. Cl. CPC H02K 33/00
USPC 310/17

(57) ABSTRACT

Disclosed herein is a vibration motor. In the vibration motor according to the present invention, an external power source is connected by a method of using a connecter, which is an improved method of a soldering method according to the prior art, such that accurate assembling, stable maintenance, and stabilization may be performed. Therefore, a yield for connecting the external power source to the vibration motor may be improved, and a work time may be significantly reduced.

### CROSS REFERENCE TO RELATED ED APPLICATION

This application claims the benefit of Korean Patent Application No. 10-2011-0144916, filed on Dec. 28, 2011, entitled “Vibration Motor”, which is hereby incorporated by reference in its entirety into this application.

### BACKGROUND OF THE INVENTION

1. Technical Field

The present invention relates to a vibration motor.

2. Description of the Related Art

A vibration motor, which is a component converting electrical energy into mechanical vibration using a principle of generating electromagnetic force, is generally mounted in a portable phone, and the like, to generate a silent receiving signal, thereby preventing inconvenience to other people due to an external sound.

This vibration motor may mainly be divided into a rotary vibration motor and a linear vibration motor, wherein in the case of the rotary vibration motor, a rotor having an unbalanced mass is rotated, thereby generating mechanical vibration. Further, in the case of the linear vibration motor, the motor is oscillated and linearly driven by electromagnetic force having a resonance frequency determined using a spring and a vibrator hung on the spring, thereby generating mechanical vibration.

Here, the electromagnetic force is generated by interaction between a magnet and direct current or alternating current of a coil having a predetermined frequency.

That is, the vibration motor uses a typical magnetic circuit system of rotating the rotor having the unbalanced mass or linearly driving the vibrator hung on the spring by electromagnetic force generated by magnetic interaction between the magnet and the coil to thereby generate mechanical vibration.

Meanwhile, this vibration motor includes an input terminal for applying power and is connected to an external power source using a soldering method of disposing a terminal of a subsidiary material such as a lead wire, a flexible printed circuit board, or the like, on the input terminal and soldering them to connect the terminals to each other.

A detail description thereof is disclosed in Patent Document 1. Referring to Patent Document 1, as shown in FIGS. 1 to 3, an input terminal connected to a coil is exposed to the outside of a case, and after an external power line is overlapped with the input terminal, the external power line and the input terminal are soldered to a printed circuit board to each other to form a soldering part, thereby connecting the input terminal to an external power source.

### PRIOR ART DOCUMENT

### Patent Document

(Patent Document 1) KR20-0447398 Y1

### SUMMARY OF THE INVENTION

However, in connection between an external power source and a vibration motor disclosed in the prior art including Patent Document 1, the case in which a position of a terminal part of a lead wire or a flexible printed circuit board, which is a subsidiary material, is changed may be generated, such that a soldering standard may not be satisfied.

That is, according to the prior art, since soldering is performed in a state in which the lead wire or the terminal part of the flexible printed circuit board is simply disposed on an input terminal of the vibration motor and overlapped with the input terminal, positions of the input terminal and the lead wire or the terminal part may frequently deviate from each other, which may degrade reliability associated with connection of an external power source.

In addition, according to the prior art, since an external power source is connected by a soldering method of performing primary soldering on input and output terminals one by one in a state in which the terminal part of the lead wire or the flexible printed circuit board disposed on the input terminal to thereby be overlapped with each other and then performing secondary UV bonding, workability may be degraded.

Therefore, the present invention is to solve the problems according to the prior art by installing a standardized connecter to an input terminal of a vibration motor to maintain constant connection quality between the input terminal and a subsidiary material for connecting an external power source.

The present invention has been made in an effort to provide a vibration motor capable of easily connecting an external power source and implementing standardization.

According to a preferred embodiment of the present invention, there is provided a vibration motor including: a stator in which an armature including a magnet and coil and a vibrator driven by electromagnetic force of the armature are provided; a circuit board electrically connected to the armature and including an input terminal exposed to the outside of the stator; and a connecter provided on the input terminal and including assembly holes formed in one surface thereof.

An upper surface of the connecter may be provided with injection holes that are in communication with the assembly holes.

The assembly hole may be formed in a straight shape or a semi-circular shape.

A conductive material including an adhesive may be injected into the injection hole.

A fixation pin may be inserted into the injection hole.

### BRIEF DESCRIPTION OF THE DRAWINGS

The above and other objects, features and advantages of the present invention will be more clearly understood from the following detailed description taken in conjunction with the accompanying drawings, in which:

FIG. 1 is an exploded perspective view showing a vibration motor according to a preferred embodiment of the present invention;

FIG. 2 is a cross-sectional view showing the vibration motor according to the preferred embodiment of the present invention; and

FIGS. 3 and 4 are cross-sectional views showing a connection state of an external power source through a connecter according to the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

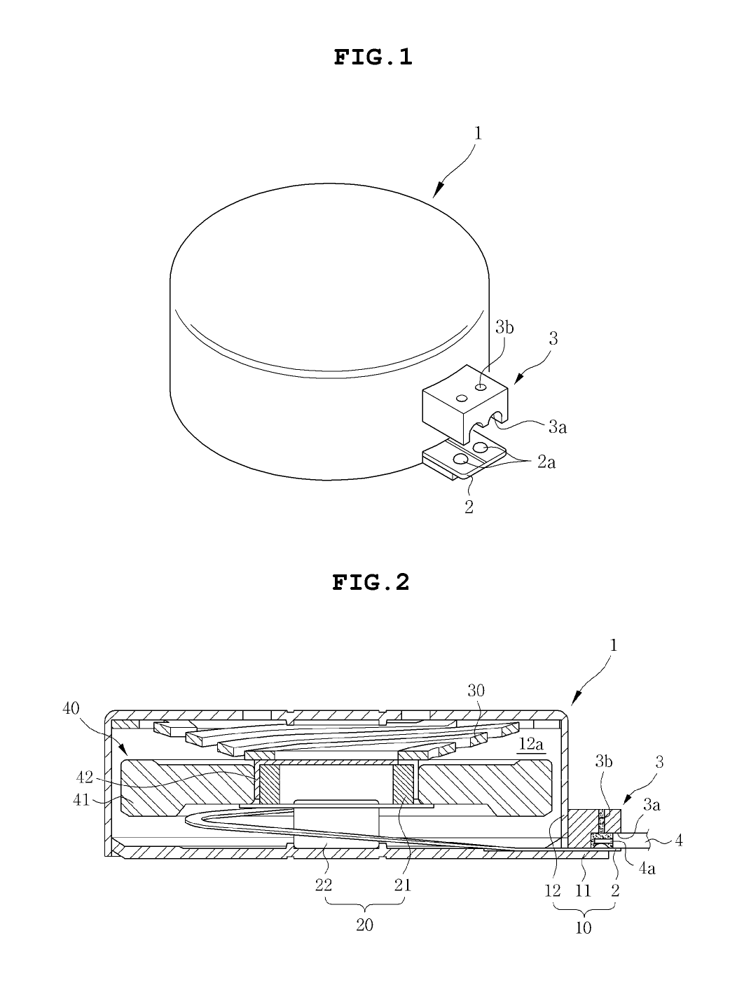

A vibration motor 1 according to the preferred embodiment of the present invention may be configured to include a circuit board 2 having an input terminal 2a configured of a general positive (+) terminal and a general negative (−) terminal to be exposed to the outside of a stator and a connecter provided on the input terminal 2a to connect an external power source as shown in FIG. 1.

Here, a subsidiary material 4 connecting the external power source to the input terminal 2a through the connecter 3 includes a lead wire or a flexible printed circuit board (FPC), and a description will be provided based on a case in which the subsidiary material includes the lead wire of the FPC. However, the case is only one example, but the present invention is not limited thereto.

The connecter 3 has an entirely rectangular parallelepiped shape and is provided on the input terminal 2a, and assembly holes 3a are formed at an opposite side to a stator 10, that is, a front surface of the connecter 3 in FIG. 1, such that a connection terminal 4a of the subsidiary material 4 electrically connected to the input terminal 2a is insertedly assembled to the assembly hole 3a.

Therefore, in the vibration motor 1 according to the present invention, the connection terminal 4a is connected in a scheme in which the connection terminal 4a is assembled to the connecter 3 instead of soldering and hardening the connection terminal 4a of the subsidiary material 3 and the input terminal 2a of the circuit board 2 to each other in a state in which they are overlapped with each other, the external power source may be easily connected.

In addition, an upper surface of the connecter 3 is provided with injection holes 3b that are in communication with the assembly holes 3a, such that applying an electric current may be performed by injecting a conductive material or through a fixation pin 3c.

That is, the electric current is applied between the input terminal 2a and the connection terminal 4a through the conductive material or the fixation pin 3c in the connecter 3, such that reliability associated with connection between the input terminal 2a and the connection terminal 4a may be improved.

In this case, the assembling holes 3a and the injection holes 3b formed in the connecter 3 are formed in pair, thereby preventing a short from being generated while applying an electric current between the input terminal 2a and the connection terminal 4a.

In addition, the assembly hole 3a may be formed to have a straight or a semi-circular shape. For example, in the case of the FPC, the assembly hole 3a is formed to have a straight shape, and in the case of the lead wire, the assembly hole 3a is formed to have a semi-circular shape. In the present invention, the case in which the assembly hole 3a has a semi-circular shape is shown.

Meanwhile, the vibration motor 1 connected to the external power source through this connecter 3 may be installed as follows. That is, as shown in FIG. 2, the vibration motor 1 includes an armature 20 including a magnet and a coil and a vibrator 40 oscillated by the armature 20 to drive in addition to the stator 10 including the above-mentioned circuit board 2.

The stator 10, which indicates components that are not driven by the electromagnetic force generated by the armature 20, includes a bracket 11 corresponding to a base of the vibration motor 1 and a case 12 corresponding to an external form of the vibration motor 1, wherein the case 12 is assembled to the bracket 11 to form an internal space 12a.

The bracket 11 is formed in a panel shape so as to easily be mounted on an external set using a surface mount technology (SMT). In addition, the circuit board 2 is provided on the bracket 11, and one end thereof is electrically connected to the armature 20, more specifically, to a coil 21, such that external power is applied to the armature 20.

In this case, the input terminal 2a provided at a distal end of the circuit board 2 is exposed to the outside of the stator 10, and the connecter 3 is provided on the input terminal 2a exposed as described above to connect the external power source.

The case 12 is formed in a cylindrical shape in which a lower portion assembled to the bracket 11 is opened and assembled on the bracket 11, thereby forming internal space 12a in the vibration motor 1. The armature 20 and the vibrator 40 are provided in the internal space 12a formed as described above.

Meanwhile, the vibrator 40 according to the present invention will be first described before describing the armature 20. The vibrator 40 is provided in the case 12 and hung on a spring 30 disposed in the internal space 12a in the present embodiment.

That is, although the case in which the vibration motor 1 according to the present invention generates mechanical vibration by linearly driving the vibrator 40 through the spring 30 is described by way of example, the vibrator 40 should be interpreted as comprehensively including all parts driven by the armature 20 to generate mechanical vibration.

However, hereinafter, a description will be provided mainly based on the present embodiment. The spring 30 transfer vibration force to the external set simultaneously with elastically supporting the vibrator 40 so that the vibrator 40 is linearly driven by the electromagnetic force generated by the armature 20.

That is, the spring 30 has a spring constant k value and determines a resonance frequency Fn of the vibration motor 1 together with a mass m of the vibrator 40. The spring 30 as described above is formed in a spiral shape so as to facilitate linear motion of the vibrator 40, is provided in the case 12, and transfers vibration force to the external set at the time of generating the vibration force while elastically supporting the vibrator 40.

The vibrator 40 includes a weight provided on the spring 30. The weight 41, which is a kind of weight body for applying a predetermined mass at the time of forming a magnetic field by the armature 20, is provided on the spring 30 in a donut shape, such that vibration force required in the vibration motor 1 may be generated.

Here, a central portion of the weight 41 is provided with a yoke 42, and the coil 21 or a magnet 22, which are the armature 20, are provided through the yoke 42 as shown in FIG. 2. Further, the coil 21 and the magnet 22 are provided so as to face each other, and one end of the circuit board 2 is electrically connected to the coil 21, such that external power is applied to form the magnetic field, thereby generating the electromagnetic force through magnetic interaction.

In the vibration motor 1 in which this armature 20 and the vibrator 40 provided on the spring 30 are sequentially assembled in the stator 10, the connection terminal 4a of the subsidiary material is inserted and assembled in the connecter 3, such that the input terminal 2a of the circuit board 2 is connected to the external power source.

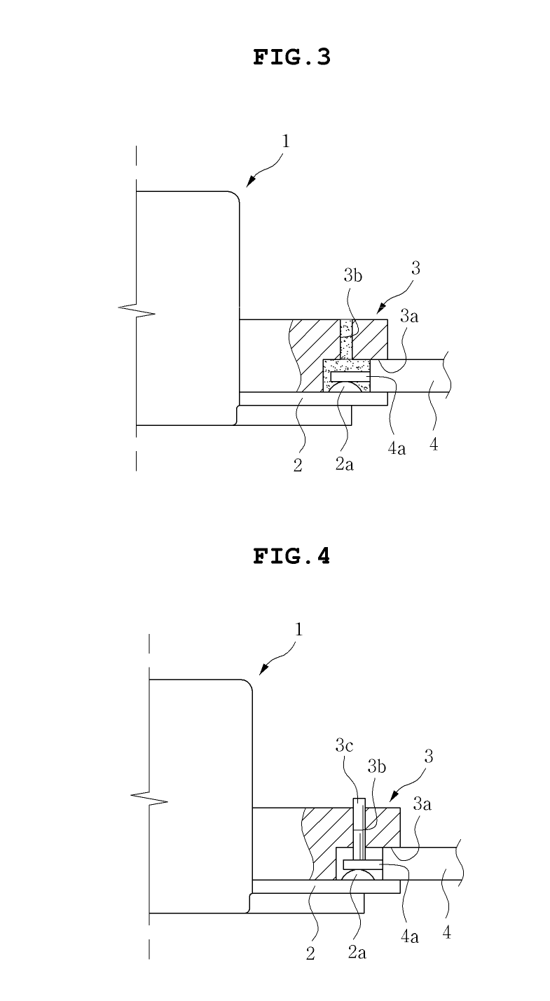

That is, as shown in FIG. 3, a conductive material including an adhesive or a solder cream, or the like, is injected into the injection hole 3b formed at the upper surface of the connecter 3 in a state in which the connection terminal 4a of the subsidiary material 4 is inserted into the assembly hole 3a formed in the connecter 3 and overlapped with the input terminal 2a.

Therefore, the conductive material injected through the injection hole 3b is appropriately applied to the connection terminal 4a and the input terminal 2a to apply an electric current between the connection terminal 4a and the input terminal 2a, such that the vibration motor 1 may be connected to the external power source.

Meanwhile, as shown in FIG. 4, the fixation pin 3c is inserted into and fixed to the injection hole formed at the upper surface of the connecter 3 in a state in which the connection terminal 4a of the subsidiary material 4 is inserted in the connecter 3 and overlapped with the input terminal 2a, such that electric current may be applied between the connection terminal 4a and the input terminal 2a.

Therefore, in the vibration motor 1 connected to the external power source as described above, power is applied to the armature 20 through the subsidiary material 4 and the circuit board 2 to form the magnetic field, and the vibrator 40 is linearly driven by this force, such that the vibration force is transferred to the external set, thereby generating a silent receiving signal.

According to the present invention, the external power source is connected to the vibration motor by the method of using a connecter instead of the soldering method according to the prior art, such that the assembling position of the input terminal and the subsidiary material may be accurately and stably maintained.

In addition, standardization through the connecter may be implemented, such that the process may be simplified, thereby making it possible to reduce cost, improve yield, and significantly reduce a work time.

Meanwhile, the conductive material is injected through the injection hole, such that an amount of applied conductive material may be easily adjusted, and the input terminal and the subsidiary material may be connected through the fixation pin inserted into the injection hole, such that a degree of freedom in design may be improved. Further, according to the present invention, reliability associated with quality may be improved.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A vibration motor comprising:
a stator in which an armature including a magnet and coil and a vibrator driven by electromagnetic force of the armature are provided;
a circuit board electrically connected to the armature and including an input terminal exposed to the outside of the stator; and
a connecter provided on the input terminal and including assembly holes formed in one surface thereof.

2. The vibration motor as set forth in claim 1, wherein an upper surface of the connecter is provided with injection holes that are in communication with the assembly holes.

3. The vibration motor as set forth in claim 2, wherein the assembly hole is formed in a straight shape or a semi-circular shape.

4. The vibration motor as set forth in claim 2, wherein a conductive material including an adhesive is injected into the injection hole.

5. The vibration motor as set forth in claim 2, wherein a fixation pin is inserted into the injection hole.
